(19) United States
(12) Patent Application Publication
(10) Pub. No.: US 2019/0314915 A1
(43) Pub. Date: Oct. 17, 2019

(54) Resistance Spot Welding Workpiece Stack-Ups Having Steel Workpieces With Surface Coatings

(71) Applicant: GM GLOBAL TECHNOLOGY OPERATIONS LLC, Detroit, MI (US)

(72) Inventors: Pei-chung Wang, Troy, MI (US); Michael J. Karagoulis, Okemos, MI (US); Zhenke Teng, Troy, MI (US); Spyros P. Mellas, Waterford, MI (US)

(21) Appl. No.: 15/952,813

(22) Filed: Apr. 13, 2018

(51) Int. Cl. B23K 1/00; B23K 11/11; B23K 11/16; B23K 11/31

(52) U.S. Cl. CPC B23K 1/0004; B23K 11/31; B23K 11/163; B23K 11/115

(57) ABSTRACT

A method of resistance spot welding a workpiece stack-up that includes a first steel workpiece and a second steel workpiece. The method includes several steps. The first steel workpiece can have a first surface coating. One step involves applying a filler metal to a surface of the first steel workpiece. Another step involves bringing a surface of the second steel workpiece to adjoin the filler metal. Yet another step involves clamping a first welding electrode and a second welding electrode on the first and second steel workpieces. And another step involves passing electrical current between the first and second welding electrodes and hence through the filler metal. And yet another step involves terminating passage of the electrical current in order to establish a weld joint between the first and second steel workpieces.

### INTRODUCTION

The present disclosure relates generally to joining metal workpieces together and, more particularly, relates to resistance spot welding steel workpieces together that have surface coatings residing on them.

Resistance spot welding is a process employed by a number of industries to join together metal workpieces. The automotive industry, for instance, uses resistance spot welding to join together steel workpieces during the manufacture of structural frame members (e.g., pillar reinforcements, beam reinforcements, and cross-member reinforcements) and during the manufacture of closure members (e.g., doors, hoods, trunk lids, and lift gates), among other uses. Advanced high-strength steels (AHSS) are a family of steel materials that have been introduced more recently for certain automobile members. Surface coatings are often provided on automobile members—whether the members are made of AHSS materials or other steel materials—for protection against exposure to the environment outside of the associated automobile, and for other reasons.

### SUMMARY

In an embodiment, a method of resistance spot welding a workpiece stack-up includes several steps. The workpiece stack-up includes a first steel workpiece and a second steel workpiece. One step involves providing the first steel workpiece and providing the second steel workpiece. The first steel workpiece has a first surface coating. Another step involves applying a filler metal to a first surface of the first steel workpiece. Another step involves bringing the second steel workpiece to the first steel workpiece. A second surface of the second steel workpiece adjoins the filler metal. Yet another step involves clamping a first welding electrode and a second welding electrode on the first and second steel workpieces at the filler metal. Another step involves passing electrical current between the first and second welding electrodes and through the first and second steel workpieces. The electrical current also passes through the filler metal. And yet another step involves terminating the passage of electrical current in order to establish a weld joint between the first and second steel workpieces.

In an embodiment, the first steel workpiece is composed of an advanced high-strength steel (AHSS) material, and the second steel workpiece is likewise composed of an advanced high-strength steel (AHSS) material.

In an embodiment, the first surface coating is composed of a zinc (Zn) material.

In an embodiment, the first surface coating resides on a first exterior surface of the first steel workpiece. The first exterior surface is situated opposite the first surface to which the filler metal is applied.

In an embodiment, the second steel workpiece has a second surface coating. The second surface coating resides on a second exterior surface of the second steel workpiece. The second exterior surface is situated opposite the second surface to which the filler metal is adjoined.

In an embodiment, the filler metal is composed of a low-carbon steel material.

In an embodiment, the step of applying the filler metal involves coating the first surface of the first steel workpiece with the filler metal by way of thermal spraying.

In an embodiment, the step of applying the filler metal involves layering the filler metal on the first surface of the first steel workpiece by way of additive manufacturing.

In an embodiment, layering the filler metal on the first surface of the first steel workpiece involves 3D printing.

In an embodiment, the established weld joint includes material of the first steel workpiece, further includes material of the second steel workpiece, and also includes material of the filler metal.

In an embodiment, the first welding electrode, the second welding electrode, or both of the first and second welding electrodes, have a weld face with a radius of curvature that ranges between approximately 20 millimeters (mm) and substantially flat.

In an embodiment, the filler metal has a thickness dimension that ranges between approximately 0.05 millimeters (mm) and 2.0 mm.

In an embodiment, a method of resistance spot welding a workpiece stack-up includes several steps. The workpiece stack-up includes a first steel workpiece and a second steel workpiece. One step involves providing the first steel workpiece and providing the second steel workpiece. The first steel workpiece is composed of an advanced high-strength steel (AHSS) material, and the second steel workpiece is likewise composed of an advanced high-strength steel (AHSS) material. The first steel workpiece has a first faying surface, and has a first exterior surface situated opposite the first faying surface. Similarly, the second steel workpiece has a second faying surface, and has a second exterior surface situated opposite the second faying surface. A first surface coating resides on the first exterior surface, and a second surface coating resides on the second exterior surface. Another step involves layering a filler metal on the first faying surface of the first steel workpiece by way of additive manufacturing. Another step involves bringing the second steel workpiece to the first steel workpiece. The second faying surface of the second steel workpiece adjoins the filler metal. Yet another step involves clamping a first welding electrode and a second welding electrode on the first and second steel workpieces at the filler metal. Another step involves passing electrical current between the first and second welding electrodes. And yet another step involves terminating the passage of electrical current in order to establish a weld joint between the first and second steel workpieces.

In an embodiment, the first surface coating is composed of a zinc (Zn) material, and the second surface coating is likewise composed of a zinc (Zn) material.

In an embodiment, the filler metal is composed of a low-carbon steel material.

In an embodiment, the filler metal has a thickness dimension that ranges between approximately 0.05 millimeters (mm) and 2.0 mm.

In an embodiment, layering the filler metal on the first surface of the first steel workpiece involves 3D printing.

In an embodiment, the established weld joint includes material of the first steel workpiece, further includes material of the second steel workpiece, and also includes material of the filler metal.

In an embodiment, a method of resistance spot welding a workpiece stack-up includes several steps. The workpiece stack-up includes a first steel workpiece and a second steel workpiece. One step involves providing the first steel workpiece and providing the second steel workpiece. The first steel workpiece is composed of an advanced high-strength steel (AHSS) material, and the second steel workpiece is likewise composed of an advanced high-strength steel (AHSS) material. The first steel workpiece has a first faying surface, and has a first exterior surface situated opposite the first faying surface. Similarly, the second steel workpiece has a second faying surface, and has a second exterior surface situated opposite the second faying surface. A first surface coating resides on the first exterior surface, and a second surface coating resides on the second exterior surface. The first surface coating is composed of a zinc (Zn) material, and the second surface coating is similarly composed of a zinc (Zn) material. Another step involves layering a filler metal on the first faying surface of the first steel workpiece by way of additive manufacturing. The filler metal is composed of a low-carbon steel material. Another step involves bringing the second steel workpiece to the first steel workpiece. The second faying surface of the second steel workpiece adjoins the filler metal. Yet another step involves clamping a first welding electrode and a second welding electrode on the first and second steel workpieces at the filler metal. Another step involves passing electrical current between the first and second welding electrodes. And yet another step involves terminating the passage of electrical current in order to establish a weld joint between the first and second steel workpieces. The established weld joint includes material of the first steel workpiece, further includes material of the second steel workpiece, and also includes material of the filler metal.

In an embodiment, the filler metal has a thickness dimension that ranges between approximately 0.05 millimeters (mm) and 2.0 mm.

### BRIEF DESCRIPTION OF THE DRAWINGS

One or more aspects of the disclosure will hereinafter be described in conjunction with the appended drawings, wherein like designations denote like elements, and wherein:

FIG. 1 is a side view of a resistance spot welding assembly, a workpiece stack-up of which is depicted in sectional view;

FIG. 2 is a perspective view of a welding electrode that may be used in the resistance spot welding assembly of FIG. 1;

FIG. 3 is a microstructure of a weld joint of a workpiece stack-up that includes a pair of advanced high-strength steel (AHSS) workpieces with surface coatings;

FIG. 4 is another microstructure of a weld joint of a workpiece stack-up that includes a pair of advanced high-strength steel (AHSS) workpieces with surface coatings;

FIG. 5 depicts an embodiment of a method of resistance spot welding a workpiece stack-up that includes a pair of steel workpieces with surface coatings; and

FIG. 6 is a microstructure of a weld joint of a workpiece stack-up made by the method of resistance spot welding of FIG. 5.

### DETAILED DESCRIPTION

The methods and assemblies detailed in this description resolve shortcomings encountered when resistance spot welding workpiece stack-ups that include one or more steel workpieces with surface coatings. A filler metal is added to the workpiece stack-ups amid the resistance spot welding process. The addition has been shown to minimize—and in some cases altogether preclude—fracturing and cracking resulting from liquid metal embrittlement (LME) and caused during resistance spot welding procedures. Workpieces of coated advanced high-strength steel (AHSS) materials, in particular, have demonstrated minimization and preclusion of LME fracturing and cracking when subject of the methods and assemblies detailed herein. The resistance spot welding process described below hence effectively joins steel workpieces with an improved joint quality and joint strength. The advancements, it is thought, are due in part to lower localized temperatures accompanying the resistance spot welding process with the addition of the filler material, among other possible rationales. And while the methods and assemblies are described in the context of automotive members, skilled artisans will appreciate that the methods and assemblies are not so limited and can be employed in other contexts such as aerospace, marine, railway, and industrial equipment applications, among others.

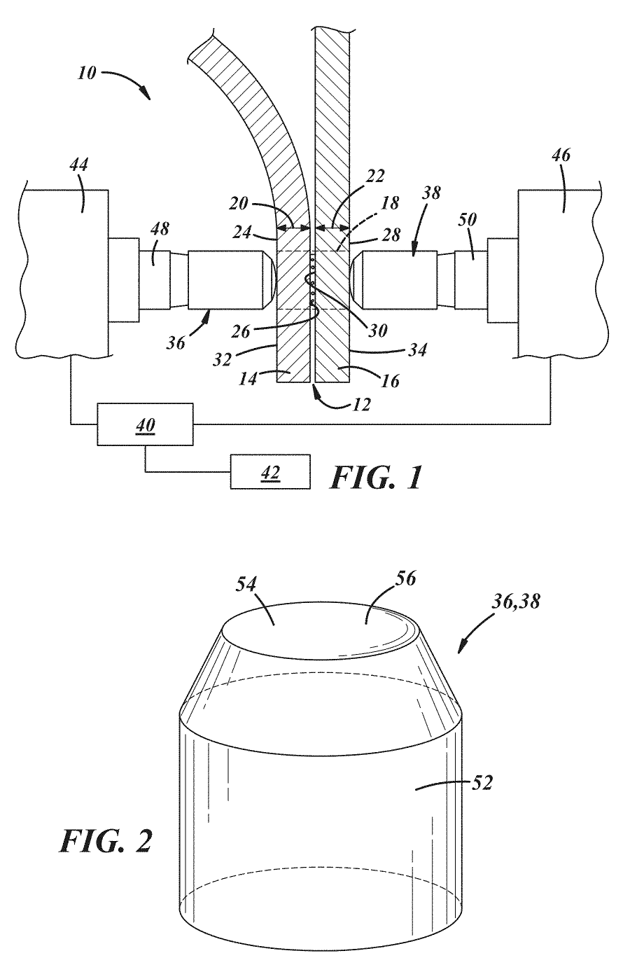

Referring now to FIG. 1, a resistance spot welding assembly 10 is used in a process to resistance spot weld a workpiece stack-up 12. In the embodiment presented, the workpiece stack-up 12 includes a first steel workpiece 14 and a second steel workpiece 16 that overlap and overlie each other at a weld site 18; still, in other embodiments the workpiece stack-up 12 can include more than two workpieces, and rather could include three or four steel workpieces that overlap and overlie one another at the weld site 18. However many are present, the steel workpieces can be composed of the same steel material relative to each other, or can be composed of different steel materials relative to each other. The steel material of the first and second steel workpieces 14, 16 can have various compositions and can take various forms depending on the particular application. In an example, the first and second steel workpieces 14, 16 are composed of an advanced high-strength steel (AHSS) material. One specific example of an AHSS material that is suitable in some applications has the material designation 980 MPa Generation 3 steel. Still, other compositions and other material designations are possible in other examples. The first steel workpiece 14 has a first thickness 20, and the second steel workpiece 16 has a second thickness 22. The first and second thicknesses 20, 22 can have the same value relative to each other, or can have a different value relative to each other. In different examples, the first and second thicknesses 20 22 can range from approximately 0.5 millimeters (mm) and 3.5 mm. The first steel workpiece 14 has a first exterior surface 24 and a first faying surface 26 situated on an opposite side thereof and, similarly, the second steel workpiece 16 has a second exterior surface 28 and a second faying surface 30 situated on an opposite side thereof.

In the embodiment presented, the first and second steel workpieces 14, 16 are coated to provide a protective barrier against certain unwanted conditions, such as against corrosion that could result from exposure to the environment outside of the associated automobile. The first steel workpiece 14 has a first surface coating 32 residing on its first exterior surface 24, and the second steel workpiece 16 has a second surface coating 34 residing on its second exterior surface 28 (the surface coatings can be layered so thinly, e.g., 50 μm or less, that a separate and distinct depiction in the FIGS. has not been illustrated). In addition to the first and second exterior surfaces 24, 28, the first and second surface coatings 32, 34 can reside on other surfaces of the first and second steel workpieces 14, 16, including on the first and second faying surfaces 26, 30. The first and second surface coatings 32, 34 can be composed of zinc (galvanized), a zinc-iron alloy (galvanneal), a zinc-nickel alloy, nickel, aluminum, an aluminum-magnesium alloy, an aluminum-zinc alloy, or an aluminum-silicon alloy; still, other compositions are possible in other examples. In other embodiments, only one of the workpieces of a particular workpiece stack-up need have a surface coating; for instance, in this embodiment the second steel workpiece 16 need not have a surface coating, and instead could be a bare steel workpiece lacking a surface coating.

Still referring to FIG. 1, in this embodiment the resistance spot welding assembly 10 includes a first welding electrode 36 and a second welding electrode 38 that pass electrical current between each other and through the workpiece stack-up 12 and through the first and second steel workpieces 14, 16 at the weld site 18. Each of the first and second welding electrodes 36, 38 is carried by a weld gun of suitable type such as a C-type or an X-type weld gun. A power supply 40 delivers electrical current to the first and second welding electrodes 36, 38 according to a programmed weld schedule administered by a weld controller 42. The weld gun can be fitted with coolant lines to deliver a coolant fluid, such as water, to each of the first and second welding electrodes 36, 38 as called for amid resistance spot welding operations. The weld gun includes a first gun arm 44 and a second gun arm 46. A first shank 48 of the first gun arm 44 secures the first welding electrode 36, and a second shank 50 of the second gun arm 46 secures the second welding electrode 38.

Referring now to FIG. 2, the first and second welding electrodes 36, 38 can share a similar construction, and are generally made for use with a steel workpiece like the first and second steel workpieces 14, 16. In general, and in an example, the first and second welding electrodes 36, 38 have an electrode body 52 and a weld face 54. The weld face 54 is the portion of the first and second welding electrodes 36, 38 that makes contact with the first and second exterior surfaces 24, 28 during resistance spot welding. The weld face 54 has a weld face surface 56 that may be generally planar or spherically domed. If spherically domed, the weld face surface 56 has a spherical profile with a radius of curvature that measures within a range of approximately 20 mm, or can be substantially and generally flat. Still, other ranges are possible in other examples.

In the automotive industry, as well as other industries, steel workpieces are joined together by resistance spot welding processes. The steel workpieces can be a part of larger automobile member assemblies, or can themselves constitute the automobile members—examples of automobile members include, but are not limited to, structural frame members (e.g., pillar and beam and cross-member reinforcements) and closure members (e.g., doors, hoods, trunk lids, and lift gates). Surface coatings are commonly provided on surfaces of the automobile members, including the surface coatings set forth above, prior to performing the resistance spot welding processes. While productive, drawbacks such as microscopic fracturing and cracking have been observed in certain cases in which resistance spot welding is carried out on steel workpieces with the surface coatings. The drawbacks have been particularly observed in workpieces of coated advanced high-strength steel (AHSS) materials.

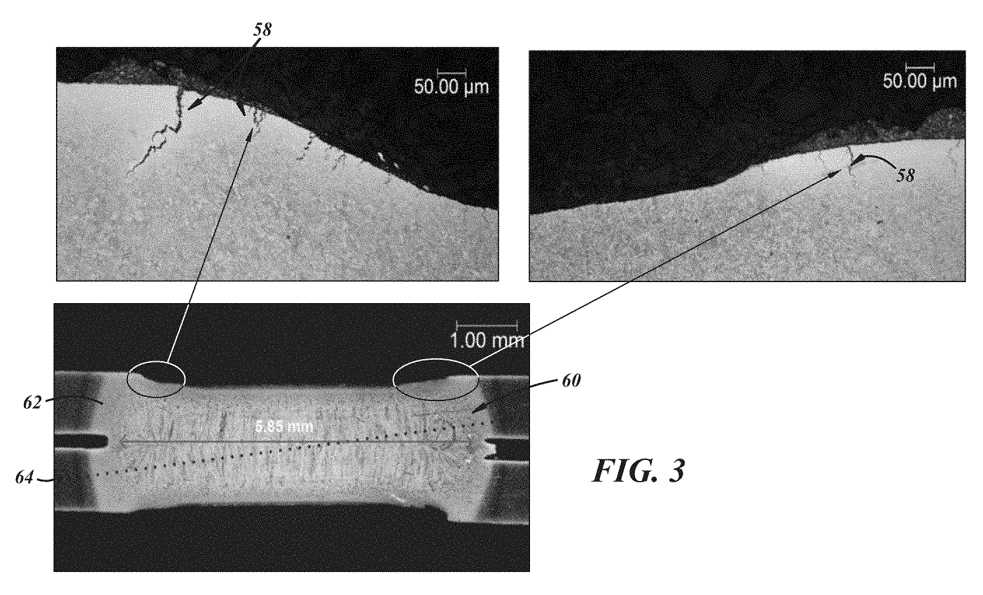

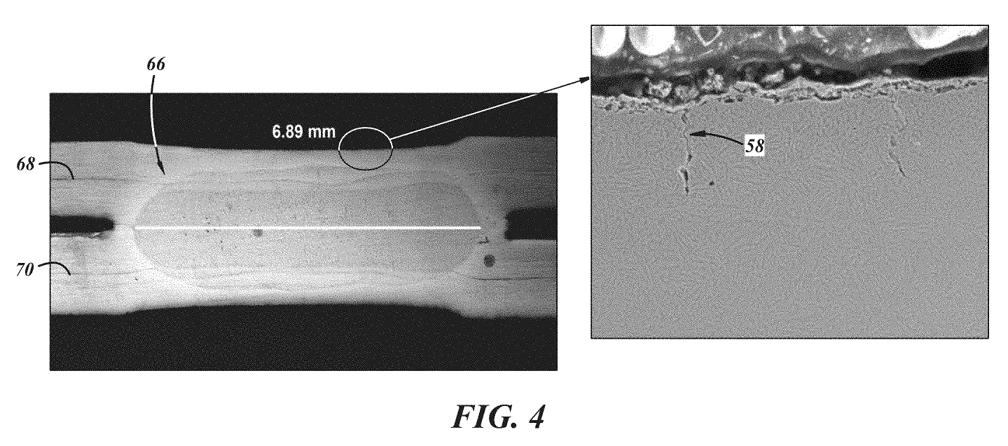

Referring now to FIGS. 3 and 4, fracturing and cracking 58 resulting from the occurrence of a phenomenon known as liquid metal embrittlement (LME) are evident in the microstructures presented. In FIG. 3, a resistance spot welded joint 60 was established between a pair of steel workpieces 62, 64. The steel workpieces 62, 64 were each composed of the AHSS steel material designated 980 MPa Generation 3 steel, each had an electro-galvanized (EG) surface coating, and each had a thickness dimension of about 1.45 mm. The fracturing and cracking 58 in the microstructure of FIG. 3 is shown enlarged and emanating from the exterior surface of the steel workpiece 62 at an outboard boundary of the resistance spot welded joint 60. In FIG. 4, a resistance spot welded joint 66 was established between a pair of steel workpieces 68, 70. The steel workpieces 68, 70 were each composed of the AHSS steel material designated 980 MPa Generation 3 steel, each had an electro-galvanneal (EGA) surface coating, and each had a thickness dimension of about 1.45 mm. The fracturing and cracking 58 in the microstructure of FIG. 4 is shown enlarged and emanating from the exterior surface of the steel workpiece 68 at an inboard site of the resistance spot welded joint 66. Moreover, in FIG. 4, analysis via energy-dispersive X-ray spectroscopy (EDS) mapping revealed the presence of melted zinc (Zn) from the EGA surface coating occupied in the fracturing and cracking 58. When present, the fracturing and cracking 58 can consequently lower joint quality and lower joint strength. Without wishing to be confined to particular theories of causation, it is thought that fracturing and cracking are the consequence of one or more of the following: i) elevated localized temperatures experienced amid resistance spot welding (i.e., ^{˜}400° C.-^{˜}900° C.) at an abutment interface between the welding electrodes and the workpieces; ii) the presence of surface coatings composed in part of a metal material; and iii) tensile stresses exerted amid resistance spot welding such as those due to thermal expansion and contraction, and loads exerted by clamping of the welding electrodes.

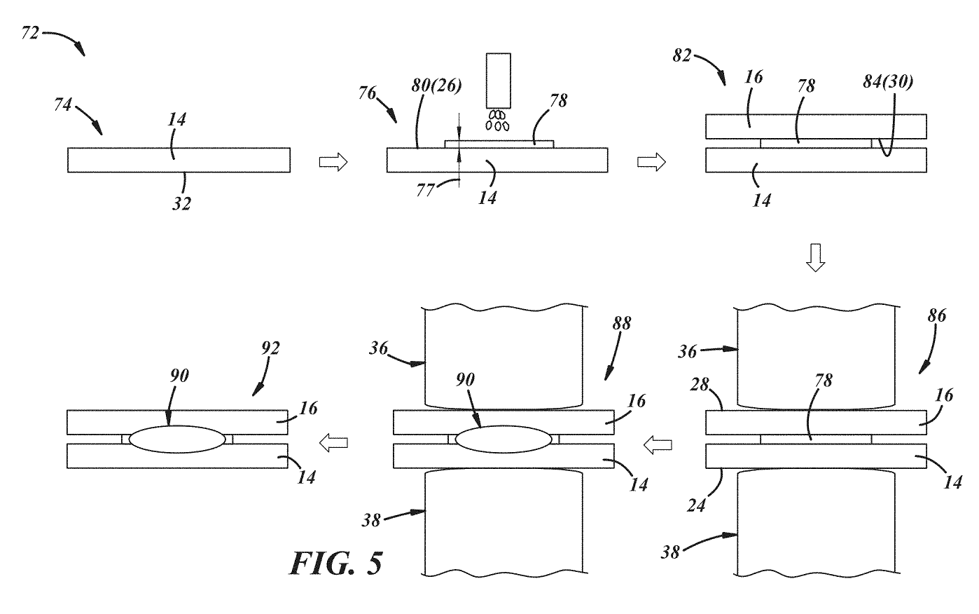

The resistance spot welding process set forth herein resolves these drawbacks. In different embodiments, the resistance spot welding process can have more, less, and/or different steps and parameters than those detailed in this description, and the steps can be performed in different orders than described. In the embodiment of FIG. 5, for example, a resistance spot welding method 72 includes a number of steps. A first step 74 involves providing the first steel workpiece 14. The first steel workpiece 14 can be provided in the forms previously described, including with the first surface coating 32. The first step 74 can also involve providing the second steel workpiece 16. The second steel workpiece 16 can likewise be provided in the forms previously described, including with the second surface coating 34.

A second step 76 of the resistance spot welding method 72 involves applying a filler metal 78 to a first surface 80 (in this case, the first faying surface 26) of the first steel workpiece 14. The filler metal 78 can be composed of various metal materials depending in part upon the material compositions of the first and second steel workpieces 14, 16 and compatibility therebetween. When the first and second steel workpieces 14, 16 are made of an AHSS steel, for instance, the filler metal 78 can have a composition of a low-carbon steel material. Still, other compositions are possible in other embodiments. The filler metal 78 can be applied to the first surface 80 by way of different application technologies and techniques. In an embodiment, the filler metal 78 is coated on the first surface 80 via a thermal spraying process in which the filler metal 78 is sprayed on the first surface 80 in a molten or semi-molten state. Types of thermal spraying processes that may be suitable in a given embodiment include, but are not limited to, plasma spraying, wire arc spraying, and laser plasma spraying. Still, other types of thermal spraying are possible in other embodiments. Further, the filler metal 78 can be layered on the first surface 80 via an additive manufacturing process. In an embodiment, the filler metal 78 is added to the first surface 80 layer-upon-layer by 3D printing. Still, other types of additive manufacturing processes are possible in other embodiments.

In the second step 76 of the resistance spot welding method 72, the filler metal 78 can be applied to the first surface 80 in different patterns and with different thicknesses. In certain embodiments, the filler metal 78 can be configured in an annular pattern, can be configured in a lined pattern, can be configured in a crossed pattern, can be configured in a solidly-filled pattern, and/or can be configured in a dotted pattern. Still, other patterns are possible in other embodiments. Whatever pattern configuration is prepared, the precise thickness dimension of the filler metal 78 applied in this step may be based upon—among other possible influences—lowering the localized temperatures attendant in subsequent steps of the resistance spot welding method 72 at abutment interfaces between the first and second welding electrodes 36, 38 and the first and second steel workpieces 14, 16, as described more below. In the second step 76, a thickness 77 of the filler metal 78 can have a value that ranges between approximately 0.05 mm and 2.0 mm. It has been determined that keeping the thickness value within this range effectively lowers the localized temperatures at the abutment interfaces between the first and second welding electrodes 36, 38 and the first and second steel workpieces 14, 16. Still, other thickness ranges are possible in other embodiments. In the same manner, the precise amount of the filler metal 78 applied in this step may be based upon—among other possible influences—lowering the localized temperatures attendant in subsequent steps of the resistance spot welding method 72 at abutment interfaces between the first and second welding electrodes 36, 38 and the first and second steel workpieces 14, 16.

A third step 82 of the resistance spot welding method 72 involves bringing the second steel workpiece 16 to the first steel workpiece 14 and over the applied filler metal 78. A second surface 84 (in this case, the second faying surface 30) of the second steel workpiece 16 comes into direct abutment with, and adjoins, the filler metal 78. In this step, the first and second steel workpieces 14, 16 overlap and overlie each other with the filler metal 78 sandwiched therebetween. A fourth step 86 of the resistance spot welding method 72 involves clamping the first and second welding electrodes 36, 38 on the first and second steel workpieces 14, 16 at the weld site 18 and over the sandwiched filler metal 78. The first and second welding electrodes 36, 38 make direct contact with the first and second exterior surfaces 24, 28, as depicted in FIG. 5. In this step, the first and second welding electrodes 36, 38 exert a clamping load on the first and second steel workpieces 14, 16. Further, a fifth step 88 of the resistance spot welding method 72 involves passing electrical current between the first and second welding electrodes 36, 38 and through the first and second steel workpieces 14, 16 and through the filler metal 78. Formation of a weld joint 90 in a molten state is initiated in this step. And a sixth step 92 of the resistance spot welding method 72 involves terminating and ceasing the passage of electrical current exchanged between the first and second welding electrodes 36, 38. The weld joint 90 previously initiated is solidified and hence established between the first and second steel workpieces 14, 16. The weld joint 90 can be a mixture of materials from the first steel workpiece 14, from the second steel workpiece 16, and from the filler metal 78.

As described, the resistance spot welding method 72 resolves the drawbacks described above and encountered when joining coated steel workpieces like the first and second steel workpieces 14, 16 with the first and second surface coatings 32, 34. The addition of the filler metal 78 has proven to lower the localized temperatures in the fifth step 88 at the abutment interfaces between weld face surfaces of the first and second welding electrodes 36, 38 and the first and second exterior surfaces 24, 28 of the first and second steel workpieces 14, 16. The localized temperatures generated at these abutment interfaces can be decreased to 1,200° C. in some embodiments. The filler metal 78 raises the number of faying interfaces present in the workpiece stack-up 12 (i.e., a first faying interface is produced between the first faying surface 26 and the confronting and opposed surface of the filler metal 78, and a second faying interface is produced between the second faying surface 30 and the confronting and opposed surface of the filler metal 78) compared to a workpiece stack-up lacking the filler metal 78. The greater number of faying interfaces offers greater electrical resistance amid the fifth step 88 which can increase and may concentrate the localized temperatures thereat, and may more readily initiate and establish a weld joint like the weld joint 90. Further, in at least some embodiments, a minute gap can exist between the filler metal 78 and the respective first and second faying surfaces 26, 30 at the first and second faying interfaces, which again offers greater electrical resistance amid the fifth step 88. In some cases, this means that a weld schedule with a more abbreviated weld current duration can be employed. And the shortened weld time can lessen the heat at the abutment interfaces, and can reduce the propensity of zinc (Zn) diffusing into the grain boundary of the austenite microstructure (if a particular surface coating indeed contains zinc). In a similar way, the addition of the filler metal 78—and hence the addition to the overall thickness of the workpiece stack-up 12—can abate the degree of heat that propagates to the abutment interfaces. With an increased overall thickness, a central point of heat propagation is hence displaced to a central region of the filler metal 78, as opposed to the central point being situated at the first and second faying surfaces 26, 30. Furthermore, because of the lowered localized temperatures at the abutment interfaces, the thermal expansion/contraction tensile stresses experienced at the abutment interfaces may in turn be diminished. As a result, the fracturing and cracking associated with LME and previously observed is minimized or altogether precluded by the resistance spot welding method 72.

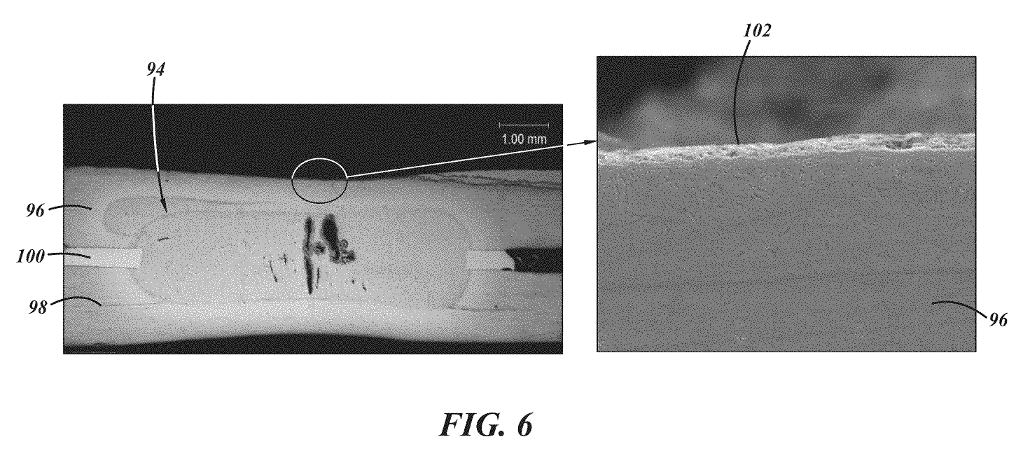

The microstructure of FIG. 6 demonstrates the preclusion of fracturing and cracking associated with LME by use of the resistance spot welding method 72. In FIG. 6, a resistance spot welded joint 94 was established between a pair of steel workpieces 96, 98 and with a filler metal 100 of 0.5 mm thickness according to a resistance spot welding process similar to the resistance spot welding method 72. The steel workpieces 96, 98 were each composed of the AHSS steel material designated 980 MPa Generation 3 steel, each had an electro-galvanneal (EGA) surface coating, and each had a thickness dimension of about 1.45 mm. And the filler metal 100 was composed of a low-carbon steel material. The enlargement in FIG. 6 evidences an absence of fracturing and cracking at an exterior surface 102 of the steel workpiece 96. Moreover, in FIG. 6, analysis via energy-dispersive X-ray spectroscopy (EDS) mapping confirmed an absence of melted zinc (Zn) from the EGA surface coating at the exterior surface 102 of the steel workpiece 96.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of resistance spot welding a workpiece stack-up that comprises a first steel workpiece and a second steel workpiece, the method comprising:
providing the first steel workpiece and providing the second steel workpiece, at least the first steel workpiece having a first surface coating;
applying a filler metal to a first surface of the first steel workpiece;
bringing the second steel workpiece to the first steel workpiece, a second surface of the second steel workpiece adjoining the filler metal;
clamping a first welding electrode and a second welding electrode on the first and second steel workpieces adjacent the filler metal;
passing electrical current between the first and second welding electrodes and through the first and second steel workpieces and through the filler metal; and
terminating passage of the electrical current to establish a weld joint between the first and second steel workpieces.

2. The method of claim 1, wherein the first steel workpiece is composed of an advanced high-strength steel (AHSS) material, and the second steel workpiece is composed of an advanced high-strength steel (AHSS) material.

3. The method of claim 1, wherein the first surface coating is composed of a zinc (Zn) material.

4. The method of claim 1, wherein the first surface coating resides on a first exterior surface of the first steel workpiece, the first exterior surface being situated opposite the first surface to which the filler metal is applied.

5. The method of claim 1, wherein the second steel workpiece has a second surface coating, the second surface coating resides on a second exterior surface of the second steel workpiece, the second exterior surface being situated opposite the second surface to which the filler metal is adjoined.

6. The method of claim 1, wherein the filler metal is composed of a low-carbon steel material.

7. The method of claim 1, wherein applying the filler metal involves coating the first surface of the first steel workpiece with the filler metal via thermal spraying.

8. The method of claim 1, wherein applying the filler metal involves layering the filler metal on the first surface of the first steel workpiece via additive manufacturing.

9. The method of claim 8, wherein layering the filler metal on the first surface of the first steel workpiece involves 3D printing.

10. The method of claim 1, wherein the established weld joint includes material of the first steel workpiece, includes material of the second steel workpiece, and includes material of the filler metal.

11. The method of claim 1, wherein the first welding electrode, the second welding electrode, or both of the first and second welding electrodes have a weld face with a radius of curvature that ranges between approximately 25 millimeters (mm) and that is approximately flat.

12. The method of claim 1, wherein the filler metal has a thickness dimension that ranges between approximately 0.05 millimeters (mm) and 2.0 mm.

13. A method of resistance spot welding a workpiece stack-up that comprises a first steel workpiece and a second steel workpiece, the method comprising:
providing the first steel workpiece and providing the second steel workpiece, the first steel workpiece being composed of an advanced high-strength steel (AHSS) material and the second steel workpiece being composed of an advanced high-strength steel (AHSS) material, the first steel workpiece having a first faying surface and having a first exterior surface situated opposite the first faying surface, the second steel workpiece having a second faying surface and having a second exterior surface situated opposite the second faying surface, a first surface coating residing on the first exterior surface, and a second surface coating residing on the second exterior surface;
layering a filler metal on the first faying surface of the first steel workpiece via additive manufacturing;
bringing the second steel workpiece to the first steel workpiece, the second faying surface of the second steel workpiece adjoining the filler metal;
clamping a first welding electrode and a second welding electrode on the first and second steel workpieces adjacent the filler metal;
passing electrical current between the first and second welding electrodes; and
terminating passage of the electrical current to establish a weld joint between the first and second steel workpieces.

14. The method of claim 13, wherein the first surface coating is composed of a zinc (Zn) material, and the second surface coating is composed of a zinc (Zn) material.

15. The method of claim 13, wherein the filler metal is composed of a low-carbon steel material.

16. The method of claim 13, wherein the filler metal has a thickness dimension that ranges between approximately 0.05 millimeters (mm) and 2.0 mm.

17. The method of claim 13, wherein layering the filler metal on the first surface of the first steel workpiece involves 3D printing.

18. The method of claim 13, wherein the established weld joint includes material of the first steel workpiece, includes material of the second steel workpiece, and includes material of the filler metal.

19. A method of resistance spot welding a workpiece stack-up that comprises a first steel workpiece and a second steel workpiece, the method comprising:
providing the first steel workpiece and providing the second steel workpiece, the first steel workpiece being composed of an advanced high-strength steel (AHSS) material and the second steel workpiece being composed of an advanced high-strength steel (AHSS) material, the first steel workpiece having a first faying surface and having a first exterior surface situated opposite the first faying surface, the second steel workpiece having a second faying surface and having a second exterior surface situated opposite the second faying surface, a first surface coating residing on the first exterior surface, and a second surface coating residing on the second exterior surface, the first surface coating being composed of a zinc (Zn) material and the second surface coating being composed of a zinc (Zn) material;
layering a filler metal on the first faying surface of the first steel workpiece via additive manufacturing, the filler metal being composed of a low-carbon steel material;
bringing the second steel workpiece to the first steel workpiece, the second faying surface of the second steel workpiece adjoining the filler metal;
clamping a first welding electrode and a second welding electrode on the first and second steel workpieces adjacent the filler metal;
passing electrical current between the first and second welding electrodes; and
terminating passage of the electrical current to establish a weld joint between the first and second steel workpieces, the weld joint including material of the first steel workpiece and including material of the second steel workpiece and including material of the filler metal.

20. The method of claim 19, wherein the filler metal has a thickness dimension that ranges between approximately 0.05 millimeters (mm) and 2.0 mm.
